(19) United States
(12) Patent Application Publication
(10) Pub. No.: US 2002/0188690 A1
(43) Pub. Date: Dec. 12, 2002

(54) System and method for checking and correcting electronic mail address

(75) Inventor: Chul-Bum Lee, Seoul (KR)

Correspondence Address: CHAPMAN AND CUTLER, 111 WEST MONROE STREET, CHICAGO, IL, 60603, US

(73) Assignee: Thisso Technology Co., Ltd., Seoul (KR)

(21) Appl. No.: 10/142,378

(22) Filed: May 9, 2002

(30) Foreign Application Priority Data
May 10, 2001 (KR) 2001-25460

(51) Int. Cl. G06F 15/16

(52) U.S. Cl. 709/206; 709/245

(57) ABSTRACT

In a name confirmation system for supporting transmission of email to a correct address through a network, a system for checking and correcting email addresses comprises: an email address extractor for extracting an email list from various media's data formats; an email address checker for separating a host name from the extracted email list, searching a mail server of the corresponding host name, and performing access; and an email address corrector for receiving email address data that are not activated from the email address checker, and automatically and temporarily modifying the email address data.

### CROSS REFERENCE TO RELATED APPLICATION

This application is based on Korea Patent Application No. 2001-25460 filed on May 10, 2001 in the Korean Intellectual Property Office, the content of which is incorporated herein by reference.

### BACKGROUND OF THE INVENTION

(a) Field of the Invention

The present invention relates to network data transmission. More specifically, the present invention relates to a system and method for checking and correcting electronic mail (referred to as “email” hereinafter) addresses for automatically confirming previously input email addresses or automatically confirming them when they are being input so as to transmit email to an accurate host name's email account holder.

(b) Description of the Related Art

In general, email is used to transmit and receive messages stored in a computer for communication. Email messages are represented in ASCII text in most cases. However, in the case of transmitting graphic images or sound files instead of the text file, they are transmitted in an attached binary file. Users can transmit and receive email between online service users and network users both publicly and privately, even when they are not Internet users.

Email is configured to have a form of “account @ host name” and it is classified as a TCP/IP (transmission control protocol/Internet protocol). One of the most popular protocols for email transmission is the SMTP (simple mail transmission protocol), and the most popular one for email receiving is the POP3 (post office protocol 3).

In order to transmit and receive email, a host name that represents a computer address in a combination of numbers and letters so as to communicate with another computer connected to the Internet is required. However, since it is difficult for the Internet user to use, understand, and memorize addresses in the numerical format for communication with other computers, addresses in the alphabetic format are used. Since the alphabetic addresses are combined English letters used in everyday life, the Internet users can easily memorize them and conveniently communicate with other computers.

A domain name is an Internet address that is easy to memorize and is meaningful to the user. To actually search a computer on the Internet, an IP (Internet protocol) address in the numerical system is required, and in this case, a system for converting the Internet address into an IP address to find locations of Internet host names is referred to as a DNS (domain name system).

A DNS server for implementing the DNS stores a database of host names and corresponding IP's, and provides them to a computer when it requires them. For example, when a host name www.AAA.co.kr is provided to the DNS server, the DNS server notifies of an IP address of 210.91.227.136.

However, when the user inputs an incorrect host name or misspells a host name in an attempt to transmit email, the corresponding email is not delivered to a desired recipient.

### SUMMARY OF THE INVENTION

It is an object of the present invention to confirm a host name and an email account input by a user so as to send email to an accurate email account holder.

In one aspect of the present invention, in a name confirmation system for supporting transmission of electronic mail (referred to as “email” hereinafter) to a correct address through a network, a system for checking and correcting email addresses comprises: an email address extractor for extracting an email list from various media's data formats; an email address checker for separating a host name from the extracted email list, searching a mail server of the corresponding host name, and performing access; and an email address corrector for receiving email address from the email address checker, and automatically and temporarily modifying the email address.

In another aspect of the present invention, a method for checking and correcting email addresses using a system for checking and correcting the email addresses to transmit email to a correct address through a network comprises: receiving a host name of a user who will receive email, and separating the host name; checking whether a mail server corresponding to the host name exists, and checking the host name from a mail server corresponding to the host name; and automatically converting an unchecked email account and modifying it into a correct email address.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 shows a block diagram of an email address checking and correcting system according to a first preferred embodiment of the present invention;

FIGS. 2(a) and 2(b) show a flowchart for an email address checking and correcting method according to a first preferred embodiment of the present invention;

FIGS. 3(a) and 3(b) show screenshots of a process for searching a mail server having a priority and a process for checking email using instructions; and

FIG. 4 shows a flowchart for an email address checking and correcting method according to a second preferred embodiment of the present invention.

### DETAILED DESCRIPTION OF THE PREFERRED EMBODIMENTS

In the following detailed description, only the preferred embodiment of the invention has been shown and described, simply by way of illustration of the best mode contemplated by the inventor(s) of carrying out the invention. As will be realized, the invention is capable of modification in various obvious respects, all without departing from the invention. Accordingly, the drawings and description are to be regarded as illustrative in nature, and not restrictive.

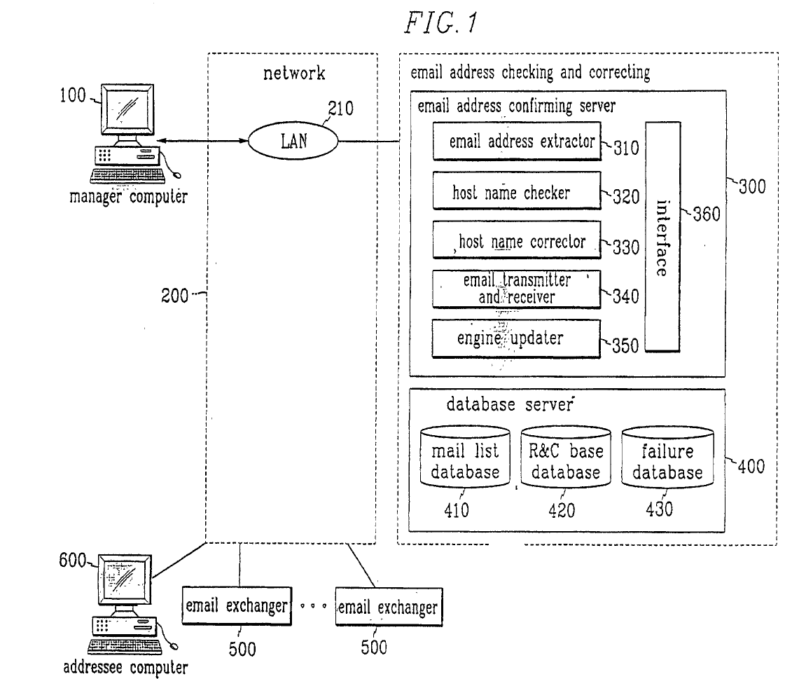

FIG. 1 shows a block diagram of an email address checking and correcting system according to a first preferred embodiment of the present invention.

As shown, the email address checking and correcting system comprises: an email address-confirming server 300 for automatically transmitting email to a temporarily converted email address using a rule & case (R&C) base when an incorrect email address is found; and a database server 400 for storing at least one of email list data, R&C base data for conversion into correct email addresses, and data that are not activated.

The email address-confirming server 300 comprises: an email address extractor 310 for extracting an email address from various media's data formats in an email list database 410; a host name checker 320 for separating a host name from the extracted email address, performing search and access processes, and checking whether a host name and an account exist; a host name corrector 330 for automatically performing a temporary modification on the non-existing email address; an email transmitter and receiver 340 for transmitting the temporarily modified email to be transmitted by an addresser to a corresponding addressee; an engine updater 350 for supporting addition, deletion, and modification of a new rule for converting a host name, and supporting a case format when a rule for determining a host name is changed; and an interface 360 for correcting the email address using a mobile station number, a fax number, or a phone number input by the addressee for activating the email address when the email address is activated to the temporarily modified email address.

The respective units of the email address-confirming server 300 may be devices for storing independent programs for performing respective functions, or a unified program into which the functions are integrated. The present invention is not restricted to the present embodiment.

The database server 400 comprises: an email list database 410 for storing at least one email list having various media's data formats; an R&C base database 420 for storing rule data and corresponding cases for the host name to be converted into a correct email address; and a failure database 430 for storing data that are passed through the interface 360 and are not activated.

The respective databases of the database server 400 may be independent information storage media for storing respective information, or they may be a single database having the databases separated into tables. The present invention is not restricted to the present embodiment.

An operation of the email address checking and correcting system according to the preferred embodiment of the present invention will now be described in detail with reference to drawings.

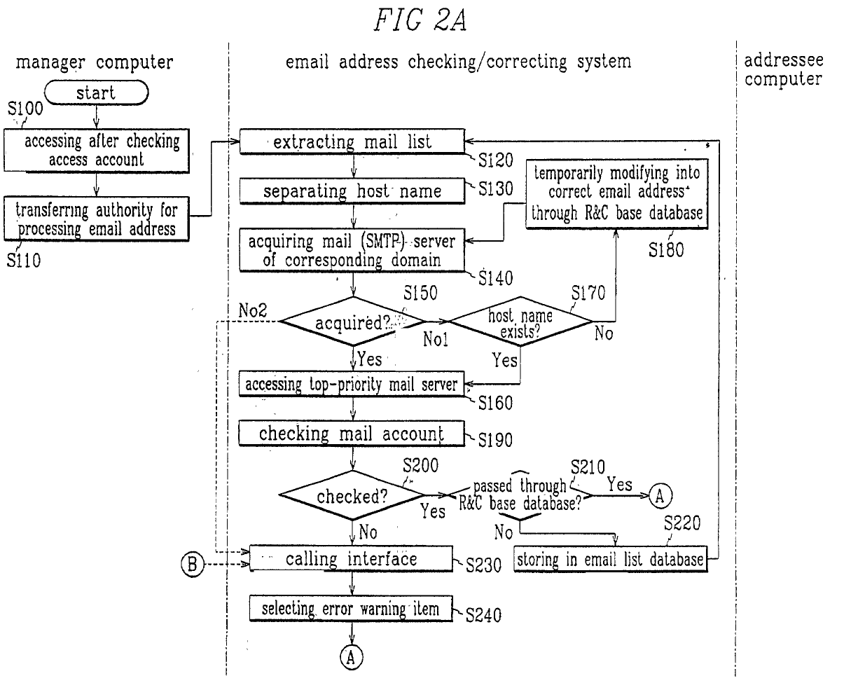

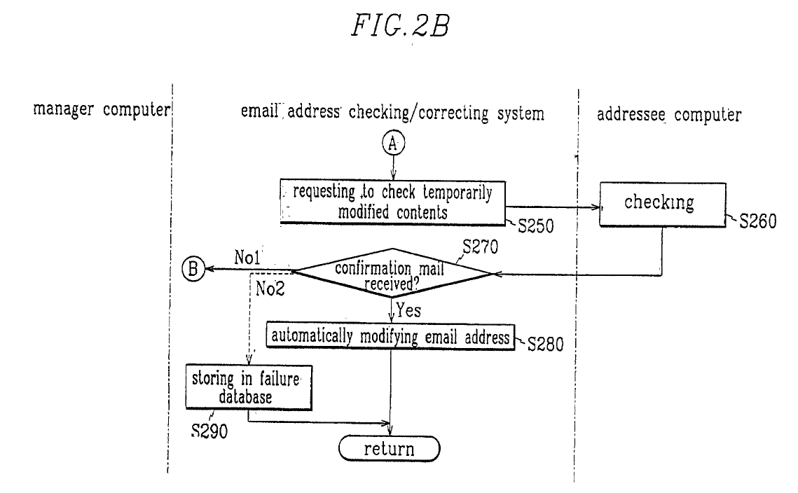

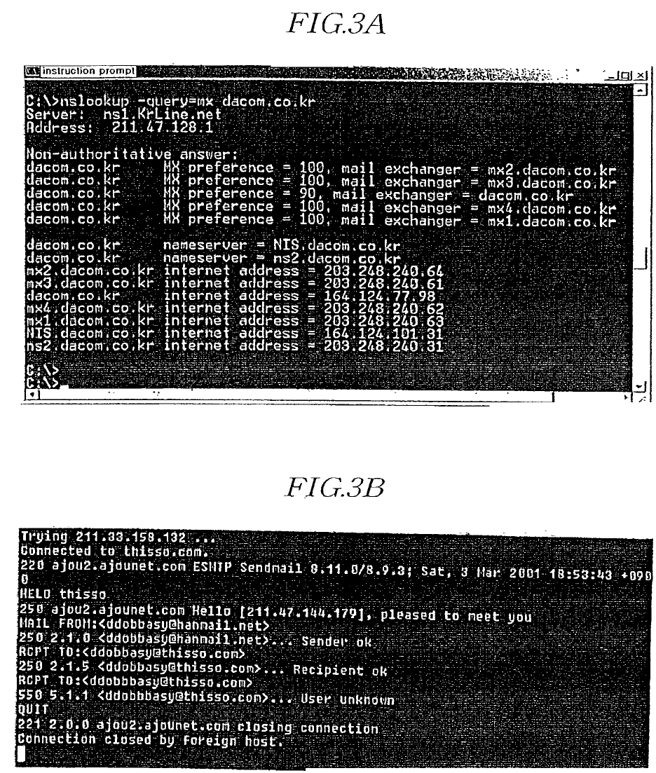

FIGS. 2(a) and 2(b) show a flowchart for an email address checking and correcting method according to a first preferred embodiment of the present invention, and FIGS. 3(a) and 3(b) show screenshots of a process for searching a mail server having a priority and a process for checking email using instructions.

As shown in FIG. 2(a), when attempting to check and correct an email address, a manager checks an access account for accessing a user database through a manager computer 100, and he accesses the system in step S100. The manager computer 100 transfers email address-processing authority to a host name checking system for checking and correcting the email address in step S110.

When receiving email data on the user from the database server 400, the email address extractor 310 of the email address-confirming server 300 extracts an email list on the user from the data stored in the email list database 410 on the basis of the received email data in step S120.

The host name checker 320 separates host names from the respective email addresses of the extracted email list in step S130. For example, in the case of “aaa@bbb.com,” it is separated into the host name of “bbb.com” and the account of “aaa.”

To acquire a mail server of the corresponding host name, the host name checker 320, as shown in FIG. 3(a), searches information on the email exchanger, and transmits a query to the corresponding mail server to acquire the corresponding host's mail server (or an SMTP server) in step S140. FIG. 3(a) represents a result confirmed by using the “NSLookUp,” which is a resolver.

The host name checker 320 checks acquisition states of the corresponding host's mail server (or an SMTP server) according to response receiving states on the transmitted query in step S150.

If the acquired mail server (or the SMTP server) exists, the host name checker 320 is TCP-connected to the mail server of the highest priority among the acquired mail servers (or SMTP servers) through the 25^{th} port so that the host name checker 320 receives an access available message from the mail server, and it is then accessed in step S160.

In this instance, when the host name checker 320 fails to acquire a mail server of the corresponding host name after checking acquisition states of the mail server of the corresponding host, the host name checker 320 checks whether a host name input by the user exists in step S170.

When the host name input by the user exists in the previous step S170, the host name checker 320 considers this host name to be the mail server and accesses the mail server.

However, when the host name input by the user does not exist, the host name corrector 330 temporarily modifies the host name into a correct host name through the rules and cases stored in the R&C base database 420 in step S180, and it goes to the previous step S140 of acquisition of the corresponding host's mail server (or the SMTP server).

That is, when the mail server (or the SMTP server) is not acquired and the host name does not exist, the host name corrector 330 temporarily modifies the email address into the correct email address according to the R&C base stored in the R&C base database 420. The rule base functions to change an incorrect email address to a correct email address.

The rule represents an experimental IF—THEN rule which is used to modify a host name of an incorrect email address by storing the rule of “If a host name is A, then it is modified into B.” in the R&C base database 420. Namely, when an incorrect email address is checked, it is sequentially applied to the rule stored in the R&C base database 420, and when it is found to be a host name of an email address that satisfies the IF sentence of a predetermined rule, it is substituted for the THEN sentence of the corresponding rule. Since most of the incorrect email addresses are typographical errors, the modification algorithm based on the experimental rule base can be applied easily. Also, since most of the email addresses used by ordinary people are provided by well-known Internet service providers, it is possible to modify the incorrect email address into the correct one according to a predetermined specific principle. Hence, the experimental algorithm for storing specific host names of the email addresses provided by the Internet service providers in the rule base according to their patterns, and modifying them, can be practically applied.

However, in the rule base reasoning, it is impossible to convert the host name when the incorrect email address is not matched with each rule, and when the incorrect email address is matched with a plurality of rules, result errors are generated. Therefore, in this case, the above-noted conversion is performed using the case base. The reasoning of using the case base counteracts the problem caused by the rule base by determining a case that is most similar to the current problem from among the previously stored experimental cases. That is, when storing the cases of converting existing incorrect email addresses to the correct email addresses in the case base, tree-type hierarchical differences are provided so that cases having common features may be stored in a high node, and as the node comes to lower node, cases may come to have different features, thereby enabling effective searching when evaluating cases to be analyzed.

For example, in the case of an email address including a comma “,” instead of a period “.” for separating the first and second level hosts, the host name corrector 340 changes the comma provided between the hosts of the email address to the period.

Example: aaa@xxx,com→aaa@xxx.com

Also, in the case of an email address with an undesired character, for example, when the “]” key and the Enter key are concurrently pressed and the character “]” is mistakenly provided at the end of the email address, the host name corrector 330 deletes the character “]” according to a predetermined rule.

Example: aaa@xxx.com]→aaa@xxx.com

Further, when a host name established according to a host rule is incorrect, for example, when a user mistakenly inputs the second host as “xo” instead of the correct host “co” to the email address, the host name corrector 330 modifies the second-level address as “co” or “go” when the first level address is “kr” and the final character of the second level is “o.”

Example: aaa@xxx.xo.kr→aaa@xxx.go.kr or aaa@xxx.co.kr

Also, when the user only knows the name of an Internet service provider and inputs incorrect first and second host names, the host name corrector 330 modifies AAA.com or AAA.co.kr into AAA.net.

Example: aaa@xxx.com or aaa@xxx.co.kr→aaa@xxx.net

bbb@yyy.net→bbb@yyy.com

After processing the step S160 of accessing email of top priority, the host name checker 320 checks an email account to find whether an account exists in the accessed mail server in step S190. In this instance, the account is checked by transmitting virtual mail through a setting before transmitting the actual email using instructions such as HELO, MAIL, FROM, RCPT TO, or VRFY. FIG. 3(b) shows a process for accessing the mail server using the instructions of HELO, MAIL, FROM, and RCPT TO, and checking for a correct and an incorrect email address.

In the first loop, with reference to FIG. 2(a), when the corresponding mail server (or the SMTP server) is not checked (NO2 of step S150) after a host name is found to not exist, and an email address is temporarily modified into a correct email address through the R&C base database, it goes to step S230 of calling an interface.

When the step S190 for checking the email account is performed, the host name checker 320 receives account-checking results from the mail server to check whether the account is checked in step S200. In this instance, when the email account is checked, the host name checker 320 checks whether the R&C base database is used in step S210.

When not used, the checked host name is recorded in the email list database 410, and it goes to the step S120 of extracting an email list in step S220.

In the step S200 of checking the email account, when receiving the result that the account is not correct from the corresponding mail server, the host name checker 320 writes the account checking result, and calls the interface 360 in step S230.

The manager operates the interface 360 to refer to the user's detailed information, and selects a method for notifying the user of email account or host name errors from among methods of sending a short message (SM), sending a correction request fax, and making a correction request call in step S240. The interface 360 performs functions including sending a correction request SM, sending a correction request fax, and making a correction request call.

That is, the function of sending a correction request SM is to send an SM for requesting a modification of the email address when email for requesting a modification of the email address is transmitted to the addresser and he does not respond to it. The function for making a correction request call is to have the addresser directly call when the correction request call is transmitted to him and he does not respond to it, so that the manager who manages the email addresses may directly call the customer to request a correction of the email address. The interface 360 can display various user options as well as the above-noted ones. The present invention is not restricted to this present embodiment.

In step S210, when the R&C base database is used, the email transmitter and receiver 340 receives temporary modification contents of the email address from the host name corrector 340, and transmits the email to the modified email address in step S250.

When the addressee checks the temporary modification contents received through the addressee computer 600, the email transmitter and receiver 340 checks whether it receives confirmation email from the addressee computer 600 in step S270. If the confirmation email is received, the manager modifies the addressee's correction confirmation contents, and the modified results are automatically or manually stored in the email list database 410 in step S280.

However, when the confirmation email is not received through the R&C base database 420 after the mail server (or the SMTP server) is acquired and the email account is checked in the first loop, it goes to the step S230 for calling the interface (NO1 of FIG. 2(b)). Again, when a receiving state of the confirmation email is not checked after a confirmation request for the temporary modification is checked in the second loop, corresponding processing results are stored in the failure database 430 in step S290.

When the process for checking and correcting all the email addresses is finished and corresponding processing results are stored in the database, the manager transmits campaign mail through a predetermined email transmission application program.

A method for checking and correcting an email address according to a second preferred embodiment of the present invention will now be described with reference to a drawing.

The second preferred embodiment is applied when a user accesses a predetermined web site service provider and inputs membership information for member registration. It is assumed in the below that each service provider installs a solution for processing the email address checking and correcting method applied to the first preferred embodiment and stores the solution in a service provider server. The service provider server may be a web server for providing web service environments to users, and it is not restricted to the present preferred embodiment.

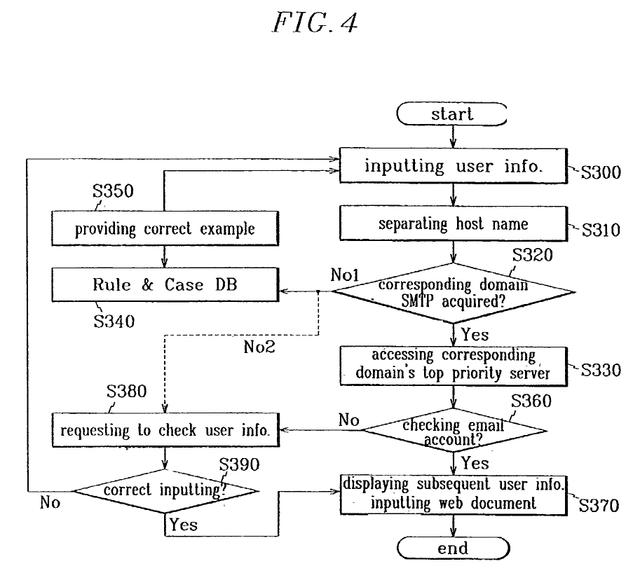

FIG. 4 shows a flowchart of a method for checking and correcting an email address according to a second preferred embodiment of the present invention.

When a user inputs user information to a membership registration web document in step S300, the corresponding service provider server extracts the user's email address input by the user to separate a host name therefrom in step S310.

The service provider server checks acquisition states of a mail server (or an SMTP server) corresponding to the host name through a network in step S320. If the mail server is acquired, the service provider server accesses the top-priority mail server of the corresponding host name in step S330.

In this instance, when the service provider server fails to acquire the mail server (NO1 in the first loop), the service provider server provides, in step S350, a correct “example” in a web memo form through the R&C database in step S340. By providing the correct example, it displays a window for the user to input again a correct email address to the user computer. By including the various user options of the first preferred embodiment to the above-noted stage of providing an example, the stage of providing an example may be connected to the email address checking and correcting system. The present invention is not restricted to the current embodiment. When the SMTP of the corresponding domain is not acquired in the second loop (NO2), it goes to a step S380 for requesting to check the user's input.

When the access of the top-priority server is finished, the service provider server checks the email account of the email address input by the user in step S360. When the account is checked according to the result of checking the email account, the service provider server displays a subsequent membership registration process web document to the user computer in step S370.

If the email account is not checked, the service provider server requests the user to reconfirm it in step S380, and again checks the contents reconfirmed and input by the user in step S390, thereby supporting the correct email address input process.

As described above, the email address checking and correcting system and method according to the present invention checks the host name and the email account input by the user so that the email may be forwarded to the correct email account holder.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

What is claimed is:

1. In a name confirmation system for supporting transmission of email to a correct address through a network, a system for checking and correcting email addresses, comprising:
an email address extractor for extracting an email list from various media's data formats;
an email address checker for separating a host name from the extracted email list, searching a mail server of the corresponding host name, and performing access; and
an email address corrector for receiving email address from the email address checker, and automatically and temporarily modifying the email address.

2. The system of claim 1, further comprising:
an email transmitter and receiver for transmitting the temporarily modified email address to a corresponding email addressee, and processing permission states of confirming the modification by the addressee on the temporarily modified email address;
an interface for providing at least one email service item and requesting an email addresser to correct the email address, when the email addresser does not respond to the email that requires correction;
an engine updater for supporting addition, deletion, and modification of the host name according to a new rule format when the rule for defining the host name is changed; and
a data storage unit for storing rule and case data of a host name that will be converted into a correct host name, on the basis of at least one email list.

3. The system of claim 2, wherein the data storage unit comprises:
an email list database for storing at least one email list having various media's data format;
a rule base database for storing rules of the host name that will be converted into a correct host name; and
an inactive database for storing email address data that are not corrected through the interface.

4. A method for checking and correcting email addresses using a system for checking and correcting the email addresses to transmit email to a correct address through a network, comprising:
receiving a host name of a user who will receive email, and separating the host name;
checking whether a mail server corresponding to the host name exists, and checking the host name from a mail server corresponding to the host name; and
automatically converting an unchecked email account and modifying it into a correct email address.

5. The method of claim 4, wherein separating the host name comprises:
extracting an email list on the basis of email address data; and
processing the email address from the extracted email list, and separating the host name and the account.

6. The method of claim 4, wherein checking the host name comprises:
checking whether a mail server of the corresponding host name exists, and acquiring the mail server;
checking acquisition states of a mail server of the corresponding host name according to receiving states of a response, and accessing the top-priority mail server; and
checking the email account so as to find whether an account exists in the accessed mail server.

7. The method of claim 4, wherein modifying into a correct email address comprises:
receiving account checking results from the mail server to check whether the account is checked, and when the account is not correct, transmitting temporarily modified email address data to the user who will receive the email;
automatically processing and storing the temporarily modified email address, when a confirmation result is transmitted from the user; and
determining that the user's email address is mistakenly input, when a confirmation result is not transmitted from the user.

8. The method of claim 4, wherein modifying into a correct email address is performed using rule and case data to temporarily modify it into a correct email address.

9. The method of claim 7, further comprising:
checking whether email address processing contents to be subsequently processed exist, and when they do not exist, writing processing results; and
transmitting email to the modified email address.

10. A method for checking and correcting email addresses using an email address checking and correcting system for supporting reception of user information from a system for supporting network services and transmission of email to a correct address, comprising:
receiving a user's host name and separating the host name when the user inputs user email address information through the network;
checking whether a mail server corresponding to the host name exists; and
providing, when the mail server is not acquired, a valid application example to the user so that the user may input a correct email address.

11. The method of claim 10, comprising:
accessing the top-priority mail server of the corresponding host name and checking the email account when the mail server is acquired; and
allowing the user to check again when the email account is not checked.

12. A storage medium readable by a computer for storing programs, comprising:
receiving, through a network, a host name of a user who will receive email, and separating the host name;
checking whether a mail server corresponding to the host name exists, and checking the host name from the mail server that corresponds to the host name; and
automatically converting an unchecked email account and modifying it into a correct email address.

13. The storage medium of claim 12, wherein separating the host name comprises:
extracting an email list on the basis of the received email address data; and
processing an email address from the extracted email list and separating a host name and an account.

14. The storage medium of claim 12, wherein checking the host name comprises:
checking whether a mail server of the corresponding host name exists, and acquiring the mail server;
checking acquisition states of the mail server of the corresponding host name according to response-receiving states, and accessing the top-priority mail server; and
checking whether an account exists in the accessed mail server.

15. The storage medium of claim 12, wherein modifying into the correct email address comprises:
receiving account-checking results from the mail server to check whether the account is checked, and when the account is not correct, transmitting temporarily modified email address data to the user who will receive email;
automatically storing the temporarily modified email address when a confirmation result is transmitted from the user; and
determining that the user's email address is mistakenly input, when the confirmation result is not transmitted from the user.

16. The storage medium of claim 12, wherein modifying into the email address is performed using rule and case data to temporarily modify it into a correct email address.

17. The storage medium of claim 15, further comprising:
checking whether email address processing contents to be subsequently processed exist, and when an email address to be processed does not exist, writing processing results; and
transmitting email to the modified email address.

18. A storage medium readable by a computer for storing programs comprising:
receiving through a network a host name of a user who will transmit email, and separating the host name;
checking whether a mail server corresponding to the host name exists; and
providing a correct application example so that the user may again input an email address, when the mail server is not acquired.

19. The storage medium of claim 18, comprising:
accessing the top-priority mail server of the corresponding host name and checking an email account when the mail server is acquired; and
allowing the user to check again when the email account is not checked.
